(19) United States
(12) Patent Application Publication
(10) Pub. No.: US 2021/0114232 A1
(43) Pub. Date: Apr. 22, 2021

(54) GRIPPING MECHANISM

(71) Applicant: KYOCERA Document Solutions Inc., Osaka-shi (JP)

(72) Inventor: Koji IZUMI, Osaka-shi (JP)

(21) Appl. No.: 17/064,825

(22) Filed: Oct. 7, 2020

(30) Foreign Application Priority Data
Oct. 18, 2019 (JP) 2019-190950

(51) Int. Cl. B25J 15/00

(52) U.S. Cl. CPC B25J 15/0033

(57) ABSTRACT

A gripping mechanism includes a gripping body and a frame body. The frame body accommodates the gripping body and includes a plate-shaped part that grips a grasped part of an object. The gripping body has a flat surface that grips the grasped part. The gripping mechanism grips the grasped part of the object between the flat surface of the gripping body and an inner surface of the plate-shaped part of the frame body by the action of gravity operating on the gripping body.

### INCORPORATION BY REFERENCE

This application is based upon and claims the benefit of priority from the corresponding Japanese Patent Application No. 2019-190950 filed on Oct. 18, 2019, the entire contents of which are incorporated herein by reference.

### FIELD

The present disclosure relates to a gripping mechanism.

### BACKGROUND

A typical automated assembling apparatus includes a chuck mechanism for gripping parts for transport purposes. The chuck mechanism is an electric gripping mechanism. In addition, a gripping mechanism using air suction or electric suction is known.

Typical gripping mechanisms utilize power, such as a pneumatic or electrical energy, and are therefore costly and prone to failure.

### SUMMARY

A gripping mechanism according to the present disclosure includes a gripping body and a frame body. The frame body accommodates the gripping body and includes a plate-shaped part that grips a grasped part of an object. The gripping body has a flat surface that grips the grasped part. The gripping mechanism grips the grasped part of the object between the flat surface of the gripping body and an inner surface of the plate-shaped part of the frame body by an action of gravity operating on the gripping body.

### BRIEF DESCRIPTION OF THE DRAWINGS

FIG. 1 is a diagram illustrating a typical example of an assembling apparatus including a gripping mechanism according to an embodiment of the present disclosure.

FIG. 2 is a cross-sectional diagram illustrating a gripping mechanism of a related art.

FIG. 3 is a cross-sectional diagram illustrating an operation of the gripping mechanism of the related art.

FIG. 4 is an external perspective diagram illustrating a gripping mechanism according to a first embodiment of the present disclosure.

FIG. 5A, FIG. 5B, and FIG. 5C are diagrams illustrating the operation of the gripping mechanism according to the first embodiment.

FIG. 6A and FIG. 6B are diagrams illustrating a gripping body of a gripping mechanism according to a second embodiment.

FIG. 7A, FIG. 7B, and FIG. 7C are diagrams illustrating the operation of the gripping mechanism according to the second embodiment.

FIG. 8A and FIG. 8B are diagrams illustrating a gripping body of a gripping mechanism according to a third embodiment.

FIG. 9A and FIG. 9B are diagrams illustrating a gripping body of a gripping mechanism according to a fourth embodiment.

FIG. 10A, FIG. 10B, and FIG. 10C are diagrams illustrating the operation of the gripping mechanism according to the fourth embodiment.

FIG. 11A and FIG. 11B are diagrams illustrating a gripping body of a gripping mechanism according to a fifth embodiment.

### DETAILED DESCRIPTION

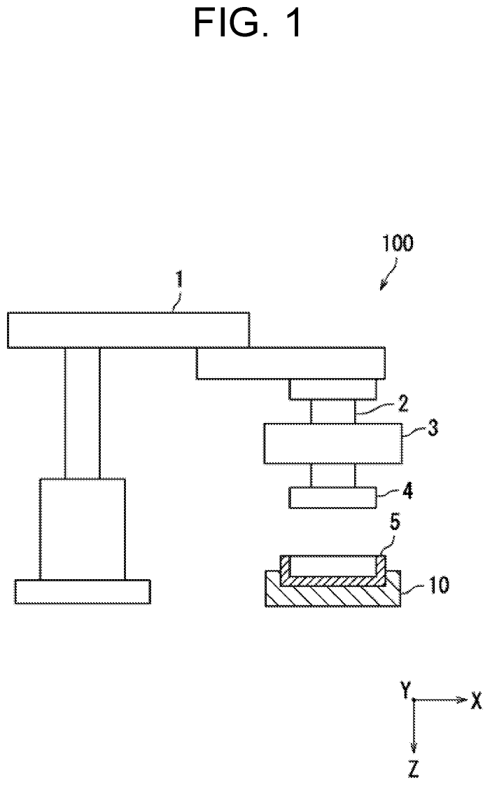

FIG. 1 illustrates a diagram of an embodiment of the present disclosure. In FIG. 1, a direction from left to right is a positive direction of an X-axis, a direction from back to front is a positive direction of a Y-axis, and a direction from top to bottom is a positive direction of a Z-axis. In the drawings, the same or corresponding parts are denoted by the same reference numerals, and a description thereof will not be repeated.

First, referring to FIG. 1, an assembling apparatus 100 including a gripping mechanism 3 according to an embodiment will be described. FIG. 1 is a diagram illustrating a front view of a typical example of the assembling apparatus 100 including the gripping mechanism 3 according to the embodiment.

As illustrated in FIG. 1, the assembling apparatus 100 is an apparatus for fitting and assembling a first component 4 to a second component 5. The assembling apparatus 100 includes a robot 1, a positional deviation correction device 2, and the gripping mechanism 3.

The gripping mechanism 3 grips the first component 4. The second component 5 is positioned on a positioning mechanism 10.

The positional deviation correction device 2 corrects a positional deviation of the first component 4 grasped by the gripping mechanism 3 with respect to the second component 5. Specifically, the positional deviation correction device 2 detects the direction of a force operating on the first component 4, when the first component 4 is fitted to the second component 5, and corrects the positional deviation of the first component 4 according to the direction of the force.

The robot 1 moves the gripping mechanism 3 relatively to the first component 4 and moves the gripping mechanism 3 relatively to the second component 5. Specifically, the robot 1 moves the gripping mechanism 3 to the storage location of the first component 4, causes the gripping mechanism 3 to grip the first component 4, and then moves the first component 4 together with the gripping mechanism 3 to the position directly above the second component 5. Thereafter, the robot 1 moves the first component 4 together with the gripping mechanism 3 in the positive direction of the Z-axis, thereby fitting the first component 4 to the second component 5. After the fitting is achieved, the robot 1 releases a gripping of the gripping mechanism 3 with respect to the first component 4 and moves the gripping mechanism 3 in the negative direction of the Z axis.

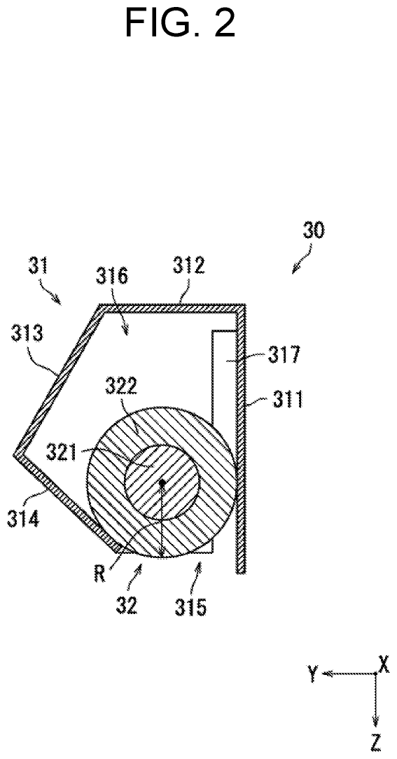

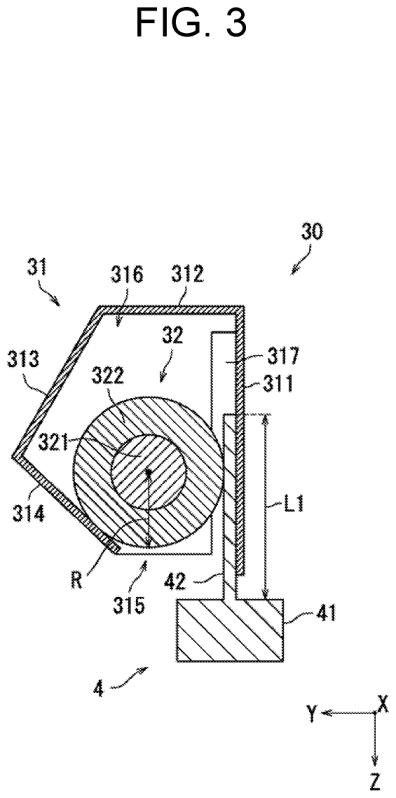

Next, referring to FIG. 2 and FIG. 3, a gripping mechanism 30 of the related art is described. FIG. 2 is a cross-sectional diagram illustrating the gripping mechanism 30 of the related art. FIG. 2 is a cross-sectional diagram in the lateral direction when the gripping mechanism 3 illustrated in FIG. 1 is used as the gripping mechanism 30 according to a reference technique. FIG. 3 is a cross-sectional diagram illustrating the operation of the gripping mechanism 30 of the related art.

As illustrated in FIG. 2, the gripping mechanism 30 includes a holder 31. The holder 31 is a frame body that accommodates a gripping roller 32, and includes a back plate 311, a top plate 312, an upper front plate 313, a lower front plate 314, and left and right side plates 316. For example, the holder 31 is made of a light metal such as aluminum.

The gripping roller 32 includes a columnar core part 321 and a covering part 322 covering a peripheral surface of the core part 321. For example, the core part 321 is made of metal such as iron, and the covering part 322 is made of an elastic body such as a polyacetal resin. The density of the core part 321 is higher than the density of the covering part 322. The covering part 322 is compressively deformable. The friction coefficient of the peripheral surface of the covering part 322 is larger than the friction coefficient of the peripheral surface of the core part 321.

The gripping roller 32 has a radius R that extends from the central axis of the core part 321 to the peripheral surface.

The back plate 311 is a rectangular plate extending along the ZX plane. The top plate 312 is a rectangular plate extending along the XY plane starting from the upper edge of the back plate 311. The upper front plate 313 is a rectangular plate that starts from the front edge of the top plate 312 and extends obliquely downward in the direction away from the back plate 311. The lower front plate 314 is a rectangular plate that starts from the lower edge of the upper front plate 313 and extends obliquely downward toward the back plate 311.

An opening 315 is formed between the back plate 311 and the lower front plate 314. The width of the opening 315 in the Y direction is smaller than the diameter 2R of the gripping roller 32. Therefore, the gripping roller 32 does not fall through the opening 315. The back plate 311 and the lower front plate 314 support the weight of the gripping roller 32. The opening 315 accepts insertion of a grasped part 42 of a component body 41 (FIG. 3).

The back plate 311, the top plate 312, the upper front plate 313, and the lower front plate 314 form substantially pentagonal openings on the left and right side surfaces of the holder 31. The left and right side plates 316 are installed so as to close these openings. In addition, the side plates 316 are openable and closable, which allows the gripping roller 32 to be easily taken in and out of the gripping mechanism 30.

At least one of the side plates 316 has, at the position close to the back plate 311, a cutout part 317 through which the grasped part 42 (FIG. 3) passes and the gripping roller 32 does not pass when the gripping is released.

Next, referring to FIG. 3, the gripping mechanism 30 of the related art will be described. FIG. 3 is a cross-sectional diagram illustrating the operation of the gripping mechanism 30 of the related art.

As illustrated in FIG. 3, the first component 4 includes the component body 41 and the grasped part 42. The component body 41 has a substantially rectangular-parallelepipedic shape. The grasped part 42 protrudes from the component body 41 so that the grasped part 42 may easily be grasped by the gripping mechanism 30. The grasped part 42 is formed in the rectangular plate shape, and an end surface of the grasped part 42 is connected to one of the main surfaces of the component body 41.

In the gripping mechanism 30 of the related art, a height L1 from the point at which the end surface of the grasped part 42 is connected to one of the main surfaces of the component body 41 to a vertex of the grasped part 42 must be larger (higher) than the radius R of the gripping roller 32.

The gripping mechanism 30 grips the grasped part 42 of the first component 4 between the outer surface of the gripping roller 32 and the inner surface of the holder 31 by the action of the gravity operating on the gripping roller 32. Specifically, in the gripping state illustrated in FIG. 3, the grasped part 42 is grasped with an appropriate frictional force between the outer surface of the covering part 322 and the inner surface of the back plate 311. Due to the compressive deformation of the covering part 322, the contact area with the grasped part 42 is increased and a large gripping force is realized as compared with the case where the covering part 322 is formed of a non-elastic body.

The operation of the assembling apparatus 100 will be described with reference to FIG. 1 to FIG. 3.

In the first step, as illustrated in FIG. 1, the robot 1 moves the gripping mechanism 30 to the storage location of the first component 4. Then, the robot 1 adjusts the posture of the gripping mechanism 30 so that the grasped part 42 and the back plate 311 are parallel to each other, and moves the gripping mechanism 30 in the positive direction of the Z axis relatively to the first component 4.

As illustrated in FIG. 3, the grasped part 42 enters the holder 31 through the opening 315, and ascends in the holder 31 while pushing aside the gripping roller 32. When the upper end of the grasped part 42 reaches at least the position higher than the center of the gripping roller 32, the movement of the gripping mechanism 30 is stopped. As a result, the gripping state illustrated in FIG. 3 is realized.

In the second step, the robot 1 moves the gripping mechanism 30 in the negative direction of the Z axis while maintaining the gripping state. As illustrated in FIG. 1, the robot 1 further moves the gripping mechanism 30 to transport the first component 4 to a top position directly above the second component 5. The grasped part 42 remains grasped between the outer surface of the covering part 322 and the inner surface of the back plate 311.

In the third step, the robot 1 moves the gripping mechanism 30 in the positive direction of the Z-axis. As a result, the first component 4 is fitted to the second component 5. In the case where the grasped part 42 slides and moves between the outer surface of the covering part 322 and the inner surface of the back plate 311 at the time of fitting, an auxiliary means for pressing the first component 4 in the positive direction of the Z-axis may be added. The gripping state illustrated FIG. 3 is maintained at least until immediately before fitting.

In the fourth step, the robot 1 moves the gripping mechanism 30 in the positive direction of the X axis (or the negative direction of the X axis). The grasped part 42 passes between the outer surface of the covering part 322 and the inner surface of the back plate 311, and further passes through the cutout part 317. As a result, the gripping of the first component 4 by the gripping mechanism 30 is released. The first component 4 remains fitted to the second component 5.

In the fifth step, the robot 1 returns the gripping mechanism 30 to the original position in preparation for the next operation while moving the gripping mechanism 30 in the negative direction of the Z axis.

Note that, in order to prevent the first component 4 from falling in the gripping state illustrated in FIG. 3, a rib extending in the X-axis direction may be provided in the vicinity of the upper edge of the main surface on the gripping roller 32 side among the two main surfaces of the grasped part 42. The action of the rib prevents the grasped part 42 from sliding and moving in the positive direction of the Z-axis between the outer surface of the covering part 322 and the inner surface of the back plate 311.

### First Embodiment

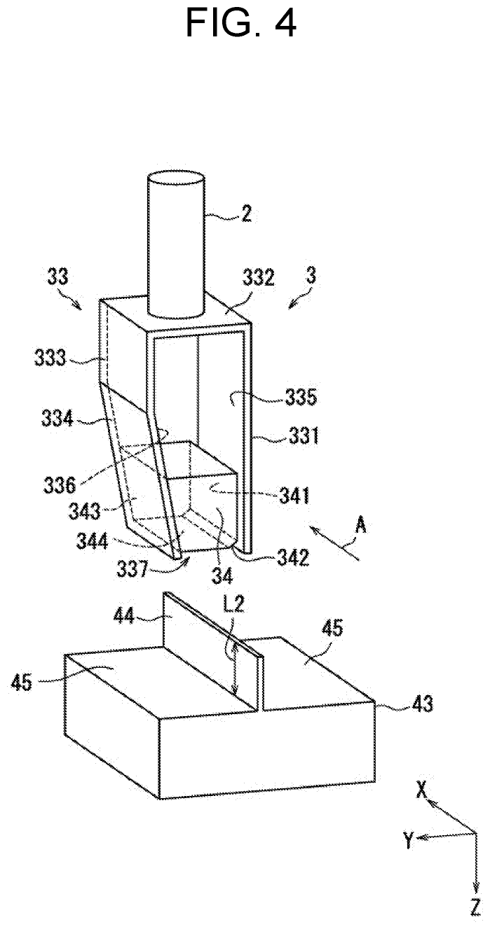

A gripping mechanism 3 according to a first embodiment of the present disclosure will be described with reference to FIG. 4 in addition to FIG. 1. FIG. 4 is an external perspective diagram illustrating the gripping mechanism 3 according to the first embodiment.

A positional deviation correction device 2 according to the first embodiment illustrated in FIG. 4 is equivalent to the positional deviation correction device 2 described with reference to FIG. 1. The gripping mechanism 3 corresponds to the gripping mechanism 30 described with reference to FIG. 2. That is, the positional deviation correction device 2 and the gripping mechanism 3 according to the first embodiment illustrated in FIG. 4 can constitute the assembling apparatus 100 described with reference to FIG. 1. Since the positional deviation correction device 2 has been described with reference to FIG. 1, the redundant description will be omitted.

As illustrated in FIG. 4, the gripping mechanism 3 includes a frame body 33 and a gripping body 34. The frame body 33 accommodates the gripping body 34, and has a plate-shaped part 331 for gripping a grasped part 44 of an object 43. The gripping body 34 has a flat surface 341 for gripping the grasped part 44. The gripping mechanism 3 grips the grasped part 44 of the object 43 between the flat surface 341 of the gripping body 34 and an inner surface 335 of the plate-shaped part 331 of the frame body 33 by the action of gravity operating on the gripping body 34.

The frame body 33 has a support part 334 for supporting the weight of the gripping body 34 together with the plate-shaped part 331, and an opening 337 for accepting the insertion of the object 43 is formed between the plate-shaped part 331 and the support part 334.

The frame body 33 of the gripping mechanism 3 accommodates the gripping body 34. The frame body 33 includes the plate-shaped part 331, a top plate 332, an upper front plate 333, and the support part 334. The frame body 33 may be made of, for example, a light metal such as aluminum. These matters can be applied in all of the present disclosure.

The plate-shaped part 331 is a rectangular planar plate extending along the ZX plane. The top plate 332 is a rectangular plate extending along the XY plane starting from the upper edge of the plate-shaped part 331. The upper front plate 333 is a rectangular plate that starts from the front edge of the top plate 332 and extends obliquely downward in the direction away from the plate-shaped part 331. The upper front plate 333 may be a rectangular plate extending vertically downward from the plate-shaped part 331 with the front edge of the top plate 332 as the starting end. The support part 334 is a rectangular plate extending obliquely downward from the lower edge of the upper front plate 333 toward the plate-shaped part 331.

The opening 337 is formed between the lower end of the plate-shaped part 331 of the frame body 33 and the lower end of the support part 334. The opening 337 accepts insertion of the grasped part 44 of the object 43.

The gripping body 34 has the flat surface 341 on the side facing the inner surface 335 of the plate-shaped part 331 of the frame body 33. The gripping body 34 sandwiches the grasped part 44 of the object 43 between the gripping body 34 in itself and the plate-shaped part 331 of the frame body 33. That is, the grasped part 44 of the object 43 is inserted between the flat surface 341 of the gripping body 34 and the inner surface 335 of the plate-shaped part 331 of the frame body 33, and the grasped part 44 of the object 43 is grasped by the flat surface 341 and the inner surface 335. Thus, the object 43 is grasped by the gripping mechanism 3.

A surface of the gripping body 34 other than the flat surface 341 may be a flat surface or a curved surface. The gripping body 34 may be a polyhedron. An inclined surface 343 on the opposite side of the flat surface 341 of the gripping body 34 faces an inner surface 336 of the support part 334 of the frame body 33. The inclined surface 343 may be a flat surface or a curved surface. However, when the inner surface 336 is a flat surface, the inclined surface 343 is preferably also a flat surface. When the inner surface 336 is a curved surface, the inclined surface 343 is preferably a curved surface having the same curvature as the inner surface 336 has. These matters can be applied in all of the present disclosure.

That is, it is preferable that the flat surface 341 of the gripping body 34 be in close contact with the inner surface 335 of the plate-shaped part 331 of the frame body 33 by the action of gravity operating on the gripping body 34. In addition, it is preferable that the inclined surface 343 of the gripping body 34 be in close contact with the inner surface 336 of the support part 334 of the frame body 33 by the action of the gravity operating on the gripping body 34.

The gripping body 34 further has a lower surface 344. In a connecting part between the lower surface 344 and the flat surface 341, a taper 342 may be provided. The taper 342 is an inclined surface so formed as to extend from the lower surface 344 toward the flat surface 341. Since the gripping body 34 has the taper 342, the object 43 is easily inserted between the gripping body 34 and the plate-shaped part 331 of the frame body 33.

The object 43 has the grasped part 44 which protrudes from an upper surface 45 of the object 43 and is grasped by the flat surface 341 of the gripping body 34 and the plate-shaped part 331 of the frame body 33.

The object 43 has, for example, a substantially rectangular-parallelepipedic shape. The grasped part 44 protrudes from the upper surface 45 of the object 43 facing the gripping mechanism 3 so that the grasped part 44 may easily be grasped by the gripping mechanism 3. The grasped part 44 may be formed integrally with the object 43. The grasped part 44 may be so formed as to connect with the upper surface 45 of the object 43.

A height L2 of the grasped part 44 may be a minimum height (distance) allowing the grasped part 44 to be sandwiched between (grasped by) the gripping body 34 and the plate-shaped part 331 of the frame body 33. The height L2 is lower (smaller) than the height L1 described with reference to FIG. 3. These matters can be applied in all of the present disclosure.

According to the present embodiment, since the grasped part 44 of the object 43 is grasped by the gripping body 34 and the frame body 33 by the action of gravity operating on the gripping body 34, the gripping mechanism 3 that is less likely to fail is provided. In addition, since the gripping body 34 has the flat surface 341 that grips the grasped part 44 of the object 43, the adhesion between the flat surface 341 of the gripping body 34 and the inner surface 335 of the plate-shaped part 331 of the frame body 33 is increased. Therefore, the gripping mechanism 3 efficiently grips the object 43, and the work efficiency of transporting the object 43 is improved.

Further, according to the present embodiment, the grasped part 44 of the object 43 is easily inserted into the frame body 33 through the opening 337. In addition, since the inclined surface 343 of the gripping body 34 is in close surface contact with the inner surface 336 of the support part 334 of the frame body 33 and the object 43 is brought into close surface contact with and sandwiched between the flat surface 341 of the gripping body 34 and the inner surface 335 of the plate-shaped part 331 of the frame body 33, the gripping mechanism 3 grips the object 43 more accurately.

Further, according to the present embodiment, since the object 43 has the grasped part 44, the frame body 33 easily grips the object 43 along with the gripping body 34. In addition, since the flat surface 341 of the gripping body 34 and the inner surface 335 of the plate-shaped part 331 of the frame body 33 are brought into close surface contact with the grasped part 44 of the object 43 so as to grip the grasped part 44, the height L2 of the grasped part 44 can be made lower (smaller) than in the case where the gripping body 34 is a cylindrical body or a spherical body, and the cost for manufacturing the grasped part 44 is reduced.

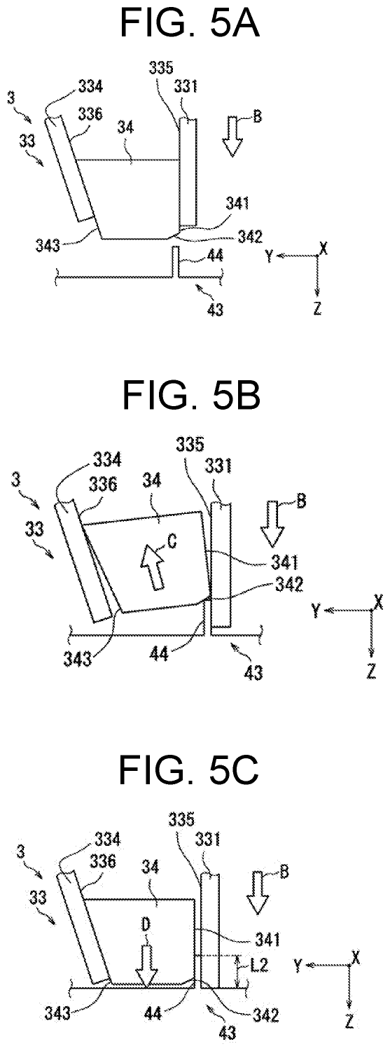

Next, the operation of the gripping mechanism 3 according to the first embodiment will be described with reference to FIGS. 5A, 5B, and 5C in addition to FIG. 1. FIG. 5A, FIG. 5B, and FIG. 5C are diagrams illustrating the operation of the gripping mechanism 3 according to the first embodiment. Descriptions overlapping with the descriptions on the structures, configurations, and effects described with reference to FIG. 4 will be omitted.

As illustrated in FIG. 5A, due to the action of gravity operating on the gripping body 34, the gripping body 34 is sandwiched between the support part 334 and the plate-shaped part 331 of the frame body 33 and stands still at the lower end of the frame body 33. At this time, the inner surface 336 of the support part 334 of the frame body 33 and the inclined surface 343 of the gripping body 34 are in close contact with each other, and the inner surface 335 of the plate-shaped part 331 of the frame body 33 and the flat surface 341 of the gripping body 34 are in close contact with each other.

The robot 1 of the assembling apparatus 100 (FIG. 1) controls the gripping mechanism 3. The robot 1 moves the gripping mechanism 3 in a direction B. The upper end of the grasped part 44 of the object 43 abuts on the taper 342 of the gripping body 34.

As illustrated in FIG. 5B, when the robot 1 continues to move the gripping mechanism 3 in the direction B, the inclined taper 342 of the gripping body 34 is urged against the grasped part 44 of the object 43, and thus the gripping body 34 is lifted in the obliquely upward direction, that is, in a direction C.

As illustrated in FIG. 5C, when the grasped part 44 of the object 43 is removed from the taper 342 of the gripping body 34, the gripping body 34 falls in the vertically downward direction (direction D).

Due to the action of gravity operating on the gripping body 34, the inner surface 336 of the support part 334 of the frame body 33 and the inclined surface 343 of the gripping body 34 are brought into close contact with each other, and the grasped part 44 of the object 43 is sandwiched between and grasped by the inner surface 335 of the plate-shaped part 331 of the frame body 33 and the flat surface 341 of the gripping body 34.

Since the inner surface 335 and the flat surface 341 are parallel to each other, the grasped part 44 of the object 43 is sandwiched between the inner surface 335 and the flat surface 341 under a strong static friction force on both side surfaces of the grasped part 44. Therefore, the height (dimension) L2 of the grasped part 44 is made low (small) as far as such a static friction force as preventing the object 43 from falling from the gripping mechanism 3 is generated on the grasped part 44.

### Second Embodiment

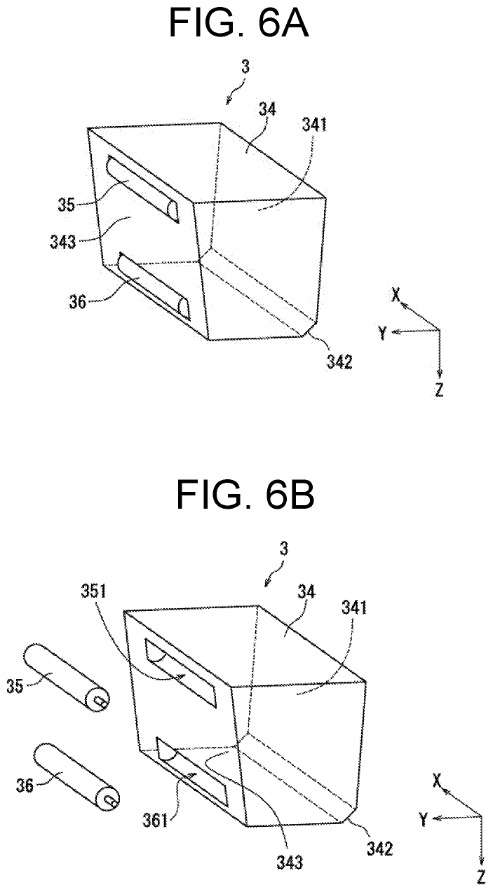

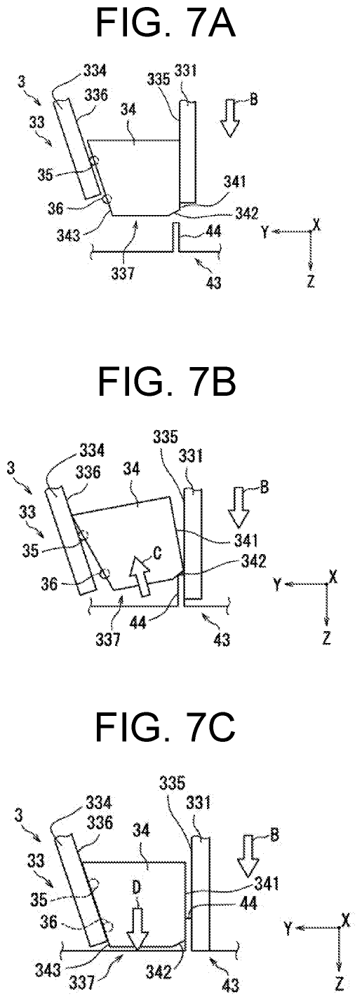

Next, the configuration of the gripping body 34 of a gripping mechanism 3 according to a second embodiment will be described with reference to FIG. 6A, FIG. 6B, FIG. 7A, FIG. 7B, and FIG. 7C in addition to FIG. 1. FIG. 6A and FIG. 6B are diagrams illustrating the gripping body 34 of the gripping mechanism 3 according to the second embodiment. FIG. 7A, FIG. 7B, and FIG. 7C are diagrams illustrating the operation of the gripping mechanism 3 according to the second embodiment. Descriptions overlapping with the descriptions on the structures, configurations, and effects described with reference to FIG. 1 to FIG. 5C will be omitted.

The gripping mechanism 3 according to the second embodiment includes a rotating body 35 or a rotating body 36 in addition to the frame body 33 and the gripping body 34. The gripping body 34 has a case 351 or a case 361 in the inclined surface 343 facing the support part 334, and the rotating body 35 or the rotating body 36 can be rotatably mounted in the case 351 or the case 361.

That is, as illustrated in FIG. 6B, the gripping body 34 has the case 351 in the inclined surface 343. The gripping body 34 has the case 361 in the inclined surface 343. In the gripping body 34, the rotating body 35 can be rotatably mounted and accommodated in the case 351. In the gripping body 34, the rotating body 36 can be rotatably mounted and accommodated in the case 361.

The case 351 and the case 361 each have an opening in the inclined surface 343. A part of each of the rotating body 35 and the rotating body 36 is projected from the opening in the inclined surface 343. The rotating bodies 35 and 36 may each be a spherical body such as a ball or a cylindrical body such as a roller. These matters can be applied in all of the present disclosure.

Since the peripheral surface of the rotating body 35 is formed of an elastic body, the rotating body 35 can be mounted in the case 351, accommodated in the case 351, and can be removed from the case 351.

Since the peripheral surface of the rotating body 36 is formed of an elastic body, the rotating body 36 can be mounted in the case 361, accommodated in the case 361, and can be removed from the case 361.

As illustrated in FIG. 7A, the robot 1 of the assembling apparatus 100 (FIG. 1) moves the frame body 33 of the gripping mechanism 3 in the direction B.

As illustrated in FIG. 7B, the upper end of the grasped part 44 of the object 43 abuts on the taper 342 of the gripping body 34. When the robot 1 continues to move the frame body 33 in the direction B, the inclined taper 342 of the gripping body 34 is urged against the grasped part 44 of the object 43, and thus the gripping body 34 is lifted in the obliquely upward direction, that is, in the direction C. In this case, since the rotating body 35 or the rotating body 36 rolls on the inner surface 336 of the support part 334 of the frame body 33, the gripping body 34 moves in the direction C with a small frictional force.

As illustrated in FIG. 7C, when the grasped part 44 of the object 43 is removed from the taper 342 of the gripping body 34, the gripping body 34 falls in the vertically downward direction (direction D). In this case, since the rotating body 35 and the rotating body 36 roll on the inner surface 336 of the support part 334 of the frame body 33, the gripping body 34 moves in the direction D with a small frictional force.

Since the inner surface 336 of the support part 334 of the frame body 33 and the peripheral surfaces of the rotating body 35 and the rotating body 36 are brought into close contact with each other by the action of gravity operating on the gripping body 34, the rotating body 35 and the rotating body 36 urge the gripping body 34. Accordingly, the grasped part 44 of the object 43 is sandwiched between and grasped by the inner surface 335 of the plate-shaped part 331 of the frame body 33 and the flat surface 341 of the gripping body 34.

According to the present embodiment, since the rotating body 35 and the rotating body 36 mounted on the gripping body 34 reduce the resistance between the support part 334 of the frame body 33 and the inclined surface 343 of the gripping body 34, the gripping body 34 easily falls after the grasped part 44 of the object 43 is inserted into the frame body 33 through the opening 337 of the frame body 33, and the object 43 is sandwiched between and grasped by the frame body 33 and the gripping body 34.

### Third Embodiment

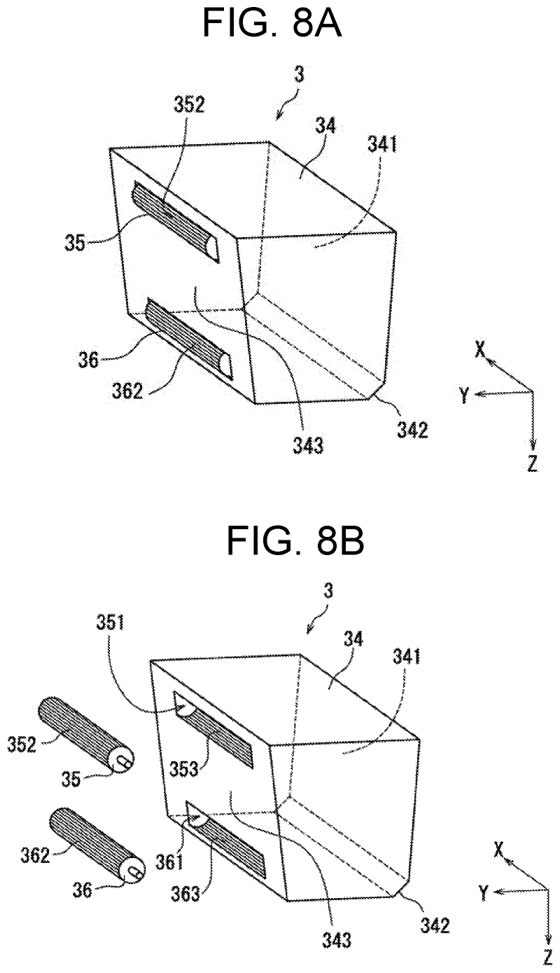

Next, the configuration and the operation of the gripping body 34 of a gripping mechanism 3 according to a third embodiment will be described with reference to FIG. 8A and FIG. 8B in addition to FIG. 1, FIG. 7A, FIG. 7B, and FIG. 7C. FIG. 8A and FIG. 8B are diagrams illustrating the gripping body 34 of the gripping mechanism 3 according to the third embodiment. Descriptions overlapping with the descriptions on the structures, configurations, and effects described with reference to FIG. 1 to FIG. 7C will be omitted.

As illustrated in FIG. 8A, the rotating body 35 has an uneven structure 352 on its peripheral surface. The rotating body 36 has an uneven structure 362 on its peripheral surface. As illustrated in FIG. 8B, the case 351 has an uneven structure 353 on a curved surface with which the peripheral surface of the rotating body 35 comes into sliding contact. The case 361 has an uneven structure 363 on a curved surface with which the peripheral surface of the rotating body 36 comes into sliding contact.

According to the present embodiment, as illustrated in FIG. 8A and FIG. 8B, when the rotating body 35 is accommodated in the case 351, the uneven structure 352 of the rotating body 35 and the uneven structure 353 of the case 351 mesh with each other, so that the rotating body 35 is prevented from idling. When the rotating body 36 is accommodated in the case 361, the uneven structure 362 of the rotating body 36 and the uneven structure 363 of the case 361 mesh with each other, so that the rotating body 36 is prevented from idling.

Similarly to the second embodiment as illustrated in FIG. 7B, when the robot 1 of the assembling apparatus 100 (FIG. 1) moves the frame body 33 of the gripping mechanism 3 in the direction B, the gripping body 34 is lifted in the direction C. At this time, since the rotating body 35 and the rotating body 36 are lowered in the vertically downward direction by their own weights, a space is formed between the rotating body 35 and the case 351, and a space is formed between the rotating body 36 and the case 361.

Therefore, when the gripping body 34 is lifted in the direction C, the rotating body 35 or the rotating body 36 can rotate, and the friction between the inclined surface 343 of the gripping body 34 and the inner surface 336 of the support part 334 is reduced.

Further, as illustrated in FIG. 7C, when the gripping body 34 falls, the uneven structure 352 of the rotating body 35 and the uneven structure 353 of the case 351 mesh with each other, and the uneven structure 362 of the rotating body 36 and the uneven structure 363 of the case 361 mesh with each other. Further, the uneven structure 352 of the rotating body 35 bites into the inner surface 336 of the support part 334 of the frame body 33, and the uneven structure 352 of the rotating body 35 is crushed. In addition, the uneven structure 362 of the rotating body 36 bites into the inner surface 336 of the support part 334 of the frame body 33, and the uneven structure 362 of the rotating body 36 is crushed.

Therefore, a large static friction force is generated between the rotating body 35 and the rotating body 36 of the gripping body 34 and the inner surface 336 of the support part 334 of the frame body 33. As a result, the gripping body 34 is more difficult to push back in the vertically upward direction than the gripping body 34 according to the second embodiment, and the grasped part 44 of the object 43 is grasped by the gripping body 34 and the plate-shaped part 331 of the frame body 33 with a static friction force stronger than the static friction force in the second embodiment.

### Fourth Embodiment

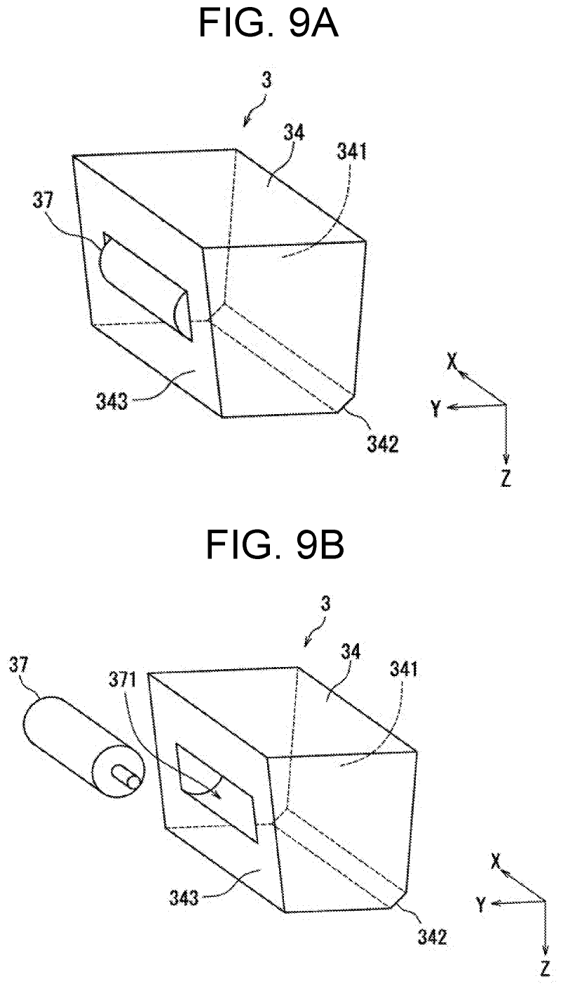

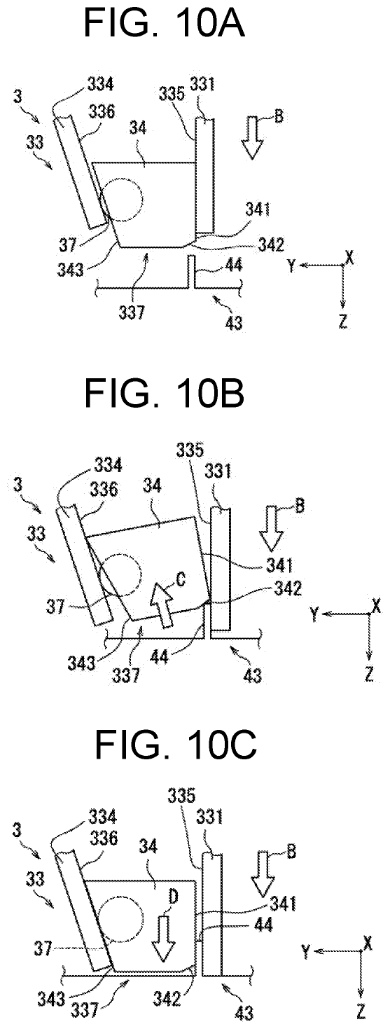

Next, the configuration of the gripping body 34 of a gripping mechanism 3 according to a fourth embodiment will be described with reference to FIG. 9A, FIG. 9B, FIG. 10A, FIG. 10B, and FIG. 10C in addition to FIG. 1. FIG. 9A and FIG. 9B are diagrams illustrating the gripping body 34 of the gripping mechanism 3 according to the fourth embodiment. FIG. 10A, FIG. 10B, and FIG. 10C are diagrams illustrating the operation of the gripping mechanism 3 according to the fourth embodiment. Descriptions overlapping with the descriptions on the structures, configurations, and effects described with reference to FIG. 1 to FIG. 8B will be omitted.

As illustrated in FIG. 9B, the gripping mechanism 3 according to the fourth embodiment includes a rotating body 37 in addition to the frame body 33 and the gripping body 34. The gripping body 34 has a case 371 in the inclined surface 343 facing the support part 334, and as illustrated in FIG. 9A, the rotating body 37 can be rotatably mounted in the case 371.

The rotating body 37 presented as an example in the fourth embodiment has a larger radius than the rotating body 35 and the rotating body 36 presented as an example in the second embodiment and the third embodiment.

The case 371 has an opening in the inclined surface 343. A part of the rotating body 37 is projected from the opening in the inclined surface 343. The rotating body 37 may be a spherical body such as a ball or a cylindrical body such as a roller. These matters can be applied in all of the present disclosure.

Since the peripheral surface of the rotating body 37 is formed of an elastic body, the rotating body 37 can be mounted in the case 371, accommodated in the case 371, and can be removed from the case 371.

As illustrated in FIG. 10A, the robot 1 of the assembling apparatus 100 (FIG. 1) moves the frame body 33 of the gripping mechanism 3 in the direction B.

As illustrated in FIG. 10B, the upper end of the grasped part 44 of the object 43 abuts on the taper 342 of the gripping body 34. When the robot 1 continues to move the frame body 33 in the direction B, the inclined taper 342 of the gripping body 34 is urged against the grasped part 44 of the object 43, and thus the gripping body 34 is lifted in the obliquely upward direction, that is, in the direction C. In this case, since the rotating body 37 rolls on the inner surface 336 of the support part 334 of the frame body 33, the gripping body 34 moves in the direction C with a small frictional force.

As illustrated in FIG. 10C, when the grasped part 44 of the object 43 is removed from the taper 342 of the gripping body 34, the gripping body 34 falls in the vertically downward direction (direction D). In this case, since the rotating body 37 rolls on the inner surface 336 of the support part 334 of the frame body 33, the gripping body 34 moves in the direction D with a small frictional force.

Since the inner surface 336 of the support part 334 of the frame body 33 and the peripheral surface of the rotating body 37 are brought into close contact with each other by the action of the gravity operating on the gripping body 34, the rotating body 37 urges the gripping body 34. Accordingly, the grasped part 44 of the object 43 is sandwiched between and grasped by the inner surface 335 of the plate-shaped part 331 of the frame body 33 and the flat surface 341 of the gripping body 34.

According to the present embodiment, the rotating body 37 mounted on the gripping body 34 reduces the resistance between the support part 334 of the frame body 33 and the inclined surface 343 of the gripping body 34. Since the radius of the rotating body 37 is large as compared with the radii of the rotating body 35 and the rotating body 36 described in the second embodiment and the third embodiment, the contact area when the rotating body 37 is in close contact with the inner surface 336 of the support part 334 of the frame body 33 is large.

Therefore, after the grasped part 44 of the object 43 is inserted into the frame body 33 through the opening 337 of the frame body 33, the gripping body 34 easily falls, and the object 43 is sandwiched between and grasped by the frame body 33 and the gripping body 34 with a more suitably strong static friction force.

### Fifth Embodiment

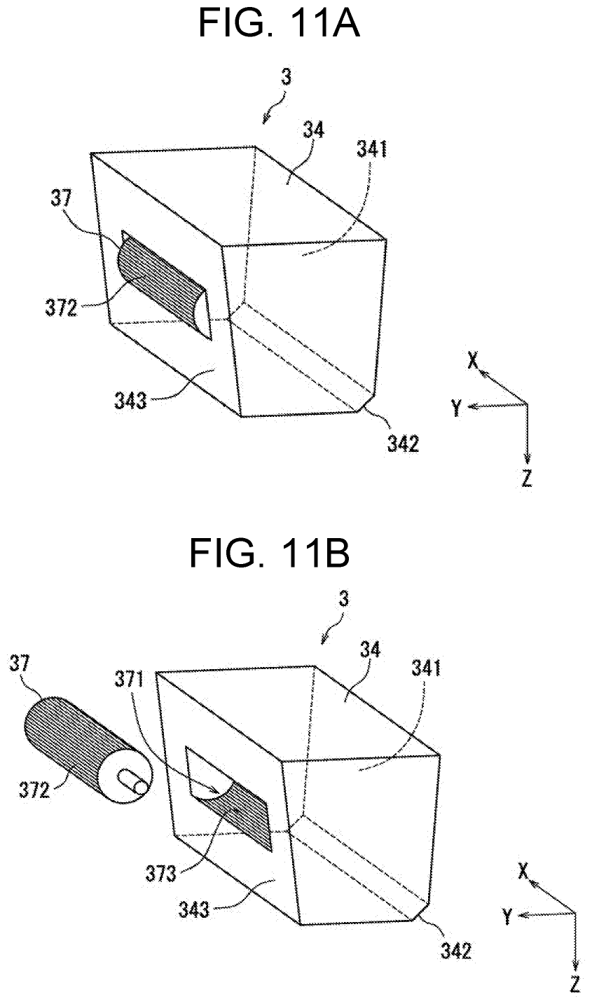

Next, the configuration and the operation of the gripping body 34 of a gripping mechanism 3 according to a fifth embodiment will be described with reference to FIG. 11A and FIG. 11B in addition to FIG. 1 and FIG. 10A to FIG. 10C. FIG. 11A and FIG. 11B are diagrams illustrating the gripping body 34 of the gripping mechanism 3 according to the fifth embodiment. Descriptions overlapping with the descriptions on the structures, configurations, and effects described with reference to FIG. 1 to FIG. 10C may be omitted.

As illustrated in FIG. 11A, the rotating body 37 has an uneven structure 372 on its peripheral surface. As illustrated in FIG. 11B, the case 371 has an uneven structure 373 on a curved surface with which the peripheral surface of the rotating body 37 comes into sliding contact.

According to the present embodiment, as illustrated in FIG. 11A, when the rotating body 37 is accommodated in the case 371, the uneven structure 372 of the rotating body 37 and the uneven structure 373 of the case 371 mesh with each other, so that the rotating body 37 is prevented from idling.

Similarly to the fourth embodiment as illustrated in FIG. 10B, when the robot 1 of the assembling apparatus 100 (FIG. 1) moves the frame body 33 of the gripping mechanism 3 in the direction B, the gripping body 34 is lifted in the direction C. At this time, since the rotating body 37 is lowered in the vertically downward direction by its own weight, a space is formed between the rotating body 37 and the case 371.

Therefore, when the gripping body 34 is lifted in the direction C, the rotating body 37 can rotate, and the friction between the inclined surface 343 of the gripping body 34 and the inner surface 336 of the support part 334 is reduced.

Further, as illustrated in FIG. 10C, when the gripping body 34 falls, the uneven structure 372 of the rotating body 37 and the uneven structure 373 of the case 371 mesh with each other. Further, the uneven structure 372 of the rotating body 37 bites into the inner surface 336 of the support part 334 of the frame body 33, and the uneven structure 372 of the rotating body 37 is crushed.

Therefore, a large static friction force is generated between the rotating body 37 of the gripping body 34 and the inner surface 336 of the support part 334 of the frame body 33. As a result, the gripping body 34 is difficult to push back in the vertically upward direction, and the grasped part 44 of the object 43 is grasped by the gripping body 34 and the plate-shaped part 331 of the frame body 33 with a suitably strong static friction force.

Further, the contact area between the peripheral surface of the rotating body 37 and the inner surface 336 of the support part 334 of the frame body 33 is increased when the rotating body 37 having a larger radius according to the fifth embodiment is provided. Therefore, the grasped part 44 of the object 43 is more suitably grasped by the gripping body 34 and the plate-shaped part 331 of the frame body 33 with a strong static friction force than in the case where the rotating body 35 and the rotating body 36 each having a small radius are provided as in the third embodiment.

According to the configuration of each embodiment of the present disclosure, a low-cost gripping mechanism that is less likely to fail is realized.

Since the description of each embodiment of the present disclosure describes a preferable embodiment of the present disclosure, a variety of technically preferable limitations may be imposed, but the technical scope of the present disclosure is not limited to the described embodiments unless any statement specifying the present disclosure is made. That is, the constituent elements in the above embodiments may be appropriately replaced with existing constituent elements or the like, and diverse variations including combinations with other existing constituent elements are possible. The above description of the embodiments does not limit the content of the disclosure in the claims.

What is claimed is:

1. A gripping mechanism comprising:
a gripping body; and
a frame body that accommodates the gripping body and includes a plate-shaped part that grips a grasped part of an object, wherein
the gripping body has a flat surface that grips the grasped part, and
the gripping mechanism grips the grasped part of the object between the flat surface of the gripping body and an inner surface of the plate-shaped part of the frame body by an action of gravity operating on the gripping body.

2. The gripping mechanism according to claim 1, wherein
the frame body includes a support part that supports a weight of the gripping body together with the plate-shaped part, and
an opening that accepts insertion of the object is formed between the plate-shaped part and the support part.

3. The gripping mechanism according to claim 2, further comprising a rotating body, wherein
the gripping body includes a case in an inclined surface facing the support part, and the rotating body is rotatably mounted in the case.

4. The gripping mechanism according to claim 1, wherein
the grasped part of the object protrudes from an upper surface of the object and is grasped by the flat surface of the gripping body and the plate-shaped part of the frame body.
